(19) United States
(12) Patent Application Publication
(10) Pub. No.: US 2026/0330045 A1
(43) Pub. Date: Oct. 22, 2026

(54) SEPARATION OF DUTIES BASED CONFLICT DETECTION AND RESOLUTION

(71) Applicant: Morgan Stanley Services Group Inc., New York, NY (US)

(72) Inventors: Hao Xu, Hong Kong SAR (CN); John K. Jordan, Glasgow (GB); Anuprita Bhatt, Bengaluru (IN); Nishi Kant, Bangaluru (IN); James McGuire, New York, NY (US)

(21) Appl. No.: 19/183,118

(22) Filed: Apr. 18, 2025

(51) Int. Cl. G06F 21/62

(52) U.S. Cl. CPC G06F 21/6218; G06F 2221/2141

(57) ABSTRACT

Systems and methods for implementing a Separation of Duties based conflict detection and resolution are disclosed. An embodiment of the present invention is directed to a policy-based detection engine that consumes different entitlement combinations of an entity's users and runs policy-based rules on attributes to detect anomalies called conflict. Once a conflict is detected, a coverage-based review mechanism may make a decision whether to maintain or revoke an entitlement.

### FIELD OF THE INVENTION

The present invention relates generally to implementing a separation of duties based conflict detection and resolution and more specifically to a policy-based detection engine that consumes different entitlement combinations to detect and resolve conflict anomalies.

### BACKGROUND

Separation of Duties (SOD) generally refers to the practice of dividing tasks among multiple users to prevent errors and fraud. SOD is based on the principle that no user should be given enough privileges to misuse the system on their own. For example, the person authorizing a paycheck should not also be the one who can prepare them. Separation of duties may be enforced by defining conflicting roles, e.g., roles which cannot be executed by the same user, as well as by enforcing the control at access time.

Existing solutions and platforms offer conflict calculations based on entitlement combinations for a user. These products follow a manual process to map such entitlements to a conflict. However, these solutions lack transparency when new entitlements are added to an existing process. In addition, the traditional method of having an audit process with SOD framework lacks sufficient entitlement coverage.

Accordingly, there is a need for an improved platform that provides for various users including System Owners, Reviewers, Approvers, and other key stakeholders to understand toxic combinations of entitlements for improved analytics and risk determinations.

### SUMMARY

Systems and methods for implementing a policy-based detection engine that consumes different entitlement combinations to detect and resolve conflict anomalies are provided.

According to an embodiment, a separation of duties based conflict detection and resolution system comprises: a computer server comprising one or more processors; a database storing business rules data; and non-transitory memory comprising instructions that, when executed by the one or more processors, cause the one or more processors to: identify one or more business processes for an application implemented by an entity; for each business process, determine a set of entitlements comprising a combination of: indirect entitlements, inheritance entitlements and root entitlements; determine a set of capabilities associated with a user; execute, via a detection engine, a set of policy-based rules to detect one or more separation of duties (SOD) conflicts for the user and the set of entitlements; provide a coverage-based review for the one or more separation of duties conflicts; and determine, via an interactive interface, whether to maintain or revoke each of the set of entitlements.

According to another embodiment, a computer-implemented method comprises the steps of: identifying one or more business processes for an application implemented by an entity; for each business process, determining a set of entitlements comprising a combination of: indirect entitlements, inheritance entitlements and root entitlements; determining a set of capabilities associated with a user; executing, via a detection engine, a set of policy-based rules to detect one or more separation of duties (SOD) conflicts for the user and the set of entitlements; providing a coverage-based review for the one or more separation of duties conflicts; and determining, via an interactive interface, whether to maintain or revoke each of the set of entitlements.

These and other advantages will be described more fully in the following detailed description.

### BRIEF DESCRIPTION OF THE DRAWINGS

In order to facilitate a fuller understanding of the invention, reference is made to the attached drawings. The drawings should not be construed as limiting the invention, but are intended only to illustrate different aspects and embodiments of the invention.

FIG. 1 is an exemplary illustration of separation of duties, according to an embodiment of the present invention.

FIG. 2 is an exemplary flowchart, according to an embodiment of the present invention.

FIG. 3 is an exemplary system diagram, according to an embodiment of the present invention.

FIG. 4 is an exemplary architecture system diagram, according to an embodiment of the present invention.

FIG. 5 is an exemplary review process, according to an embodiment of the present invention.

FIG. 6 is an exemplary conflict review process, according to an embodiment of the present invention.

FIG. 7 is an exemplary user interface, according to an embodiment of the present invention.

FIG. 8 is an exemplary flowchart, according to an embodiment of the present invention.

FIG. 9 is an exemplary flowchart, according to an embodiment of the present invention.

FIG. 10 is an illustration of privileged entitlements conflicts, according to an embodiment of the present invention.

FIG. 11 is an exemplary flowchart, according to an embodiment of the present invention.

FIG. 12 is an exemplary diagram, according to an embodiment of the present invention.

FIGS. 13A-D illustrate exemplary data structures, according to an embodiment of the present invention.

### DETAILED DESCRIPTION

Exemplary embodiments of the invention will be described in order to illustrate various features of the invention. The embodiments described herein are not intended to be limiting as to the scope of the invention, but rather are intended to provide examples of the components, use, and operation of the invention.

An embodiment of the present invention is directed to a Separation of Duties platform that implements a policy-based detection engine. The policy-based detection engine consumes various entitlement combinations of an entity's users and automatically runs policy-based rules on attributes to detect conflict anomalies.

The attributes may include: entitlement type; model; various indicators (e.g., “businessIndicator” “systemIndicator” “unstructuredDataIndicator” “privilegeAccessIndicator”, etc.); role type; identity; identifier type; grant date, revoke date; source type; fulfillment; reason for derived exclusion; expiration date, etc.

For example, a first rule may state that anyone with an ability to: manage payment limits cannot also have an ability to: facilitate cash management or complete check processing or approve payments and receipts. An embodiment of the present invention may analyze business processes for these rules and scan current entitlements to identify ones with relevant business processes. Then, the entitlements are grouped for a user. If a rule is fulfilled or otherwise triggered, a conflict may be identified and tagged against a user and rule combination.

Policy-based rules may run periodically, e.g., daily. Once a conflict is detected, a coverage-based review mechanism may be applied to determine whether to maintain or revoke the entitlement at issue. Other actions may be supported.

An embodiment of the present invention supports a variety of entitlements that may be collected and grouped together. Entitlements may include: direct, inherited, persistent, temporary, business, technology, etc. Entitlements may be within a role group and also include internal or external entitlements. An embodiment of the present invention may support Conflict As A Service for various entitlement generating and provisioning systems and services.

An embodiment of the present invention is directed to a policy-based capture of separation of duties violations elements. This may include an entitlement model and an organizational hierarchy process. An embodiment of the present invention may include a complex entitlement model for various diverging entitlement combinations; a policy-based conflict detection engine and a review process to resolve conflicts. In addition, the results of the review process may be used to further refine the overall analysis.

An embodiment of the present invention is directed to a Separation of Duties (SOD) program that may be part of a firmwide framework to identify and manage potential conflicts arising from toxic combinations of system access to reduce an entity's risk footprint. This may cover potential areas for Business (e.g., prevents system users from holding conflicting business entitlements), Technology (e.g., prevents technologists from holding conflicting entitlements across environments) and BizTech (e.g., prevents technologists from holding technology entitlements that enable them to mimic a business entitlement).

An embodiment of the present invention is directed to simplifying an entitlement model structure so that a policy may run rules. This solves challenges related to entitlement coverage and internal risk. Separation of Duties resolution is imperative to mitigate internal risk arising from toxic combinations.

An embodiment of the present invention identifies capabilities that are in conflict and is not limited to entitlements, but considers the capability of a user (e.g., what he/she can do and what he/she should not). The capabilities may then be traced back to the entitlements. By focusing on the user capability, an embodiment of the present invention identifies direct correlations to the entitlement covered through Technology SOD and Business SOD. The innovative system may further identify indirect access attained through inheritance, such as privileged access to a system leading to BizTech SOD. Considering the user's capabilities enables an embodiment of the present invention to identify and more accurately address entitlements (e.g., indirect, inheritance, etc.) that normally would be undetected or overlooked.

An embodiment of the present invention is directed to an ability to determine what is assigned to a user including individual functionalities and then mapping that information to potential conflicts. The conflict may be based on the user activity (as opposed to assignments).

An embodiment of the present invention recognizes that an assignment of a group level does not necessarily uncover conflicts that may occur through multiple layers of indirection. By tracing an entire tree of indirection, an embodiment of the present invention is able to accurately identify what a user is allowed to do and find conflicts that would have been missed otherwise.

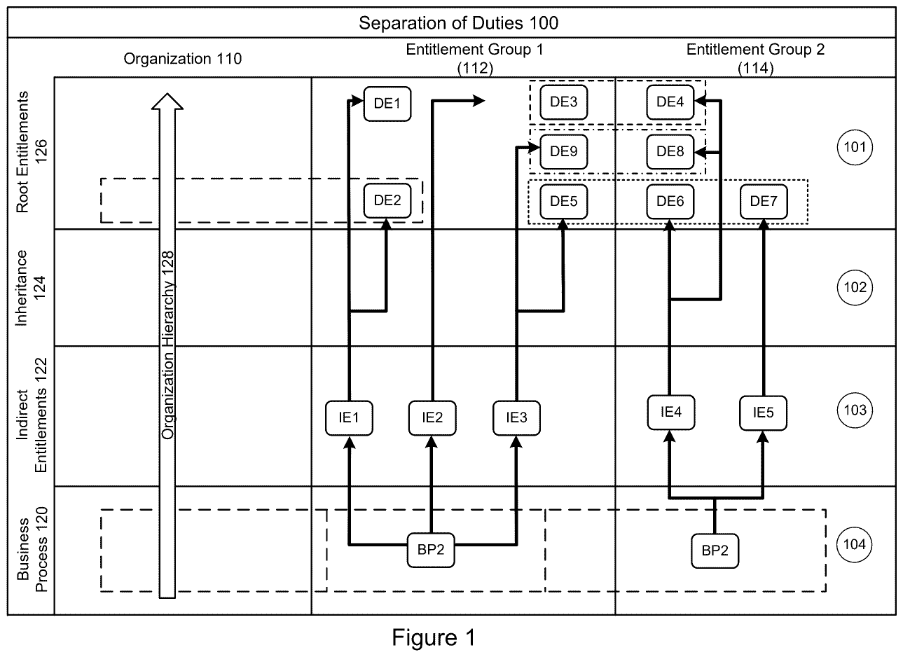

FIG. 1 is an exemplary illustration of separation of duties, according to an embodiment of the present invention. As shown by stage 101 in FIG. 1, a toxic combination of “Direct/Root entitlements” may create a conflict.

At an Organization 110, Separation of Duties 100 may be shown between Entitlement Group 1 (112) and Entitlement Group 2 (114). Separation of Duties 100 may extend from Business Process 120, Indirect Entitlements 122, Inheritance 124 to Root Entitlements 126, as shown by Organization Hierarchy 128.

Section 101 illustrates Direct Entitlements (DE). Direct Entitlements Conflicts represent conflicts arising from a combination of entitlements assigned to a user. For example, a combination of DE3 and DE4 may represent a conflict. Other combinations at issue may include DE9 and DE8 as well as DE5, DE6 and DE7.

Section 102 illustrates Inheritance Entitlements. Inheritance Entitlements may represent an entitlement lineage where one indirect entitlement governs underlying entitlements (e.g., development role (indirect entitlement) may have read and write entitlements on an asset in a DEV environment).

Section 103 illustrates Indirect Entitlements (IE). Indirect Entitlements may represent group entitlements, e.g. Developer, Administrator, Production support, etc.

Section 104 illustrates Business Process Conflicts that demonstrate conflicts arising from a combination of functionality that a user may do or combining the functionality the user may perform within an organization. According to an embodiment of the present invention, Business Processes may include capabilities that an entity may perform. For example, a process lineage may be represented by: Process Taxonomy>Finance Services>Treasury Services>Consolidate and Assess Capital Projections. Business Processes such as trade booking and trade settlement should not coexist for a user. This combination may be marked as a toxic combination of business processes. An embodiment of the present invention is directed to analyzing business processes, extracting underlying entitlements and applying business oriented rules.

Current solutions do not analyze or address SOD conflicts at the business process level and therefore fail to accurately address inherent, inheritance and other relevant entitlements.

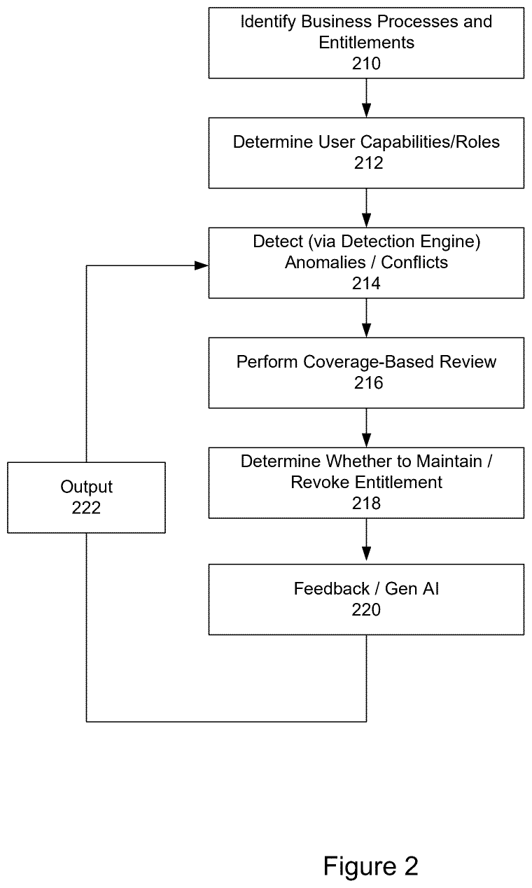

FIG. 2 is an exemplary flowchart, according to an embodiment of the present invention. At step 210, one or more business processes and associated entitlements may be identified. The business process may relate to an application implemented by an entity. For each business process, a set of entitlements may be determined. The entitlements may include: indirect entitlements, inheritance entitlements and root entitlements. At step 212, a set of capabilities or roles associated with a specific user may be determined. For example, the entitlements may be grouped for a specific user. At step 214, a detection engine may detect anomalies or conflicts based on business processes. A set of policy-based rules may be applied to detect one or more separation of duties (SOD) conflicts for the specific user and the set of entitlements. At step 216, a coverage-based review may be performed. This may include a multi-step review process. At step 218, a decision whether to maintain or revoke an entitlement may be performed.

At step 220, the output of the decision may be used to improve anomaly/conflict detection. As shown by 222, the output may be applied to step 214. For example, Generative AI (“GenAI”) may be applied in the evaluation of policies against rules and ensuring that business policies have been appropriately applied. In addition, GenAI may be used to extract detailed information relating to entitlements by evaluating descriptions provided by users in support of maintaining entitlements. This may arise when users provide detailed descriptions and/or risk justifications in support of using entitlements and how access is being used. This information may be further used to generate insights and further align the system to how users interact and use the system.

While the process of FIG. 2 illustrates certain steps performed in a particular order, it should be understood that the embodiments of the present invention may be practiced by adding one or more steps to the processes, omitting steps within the processes and/or altering the order in which one or more steps are performed.

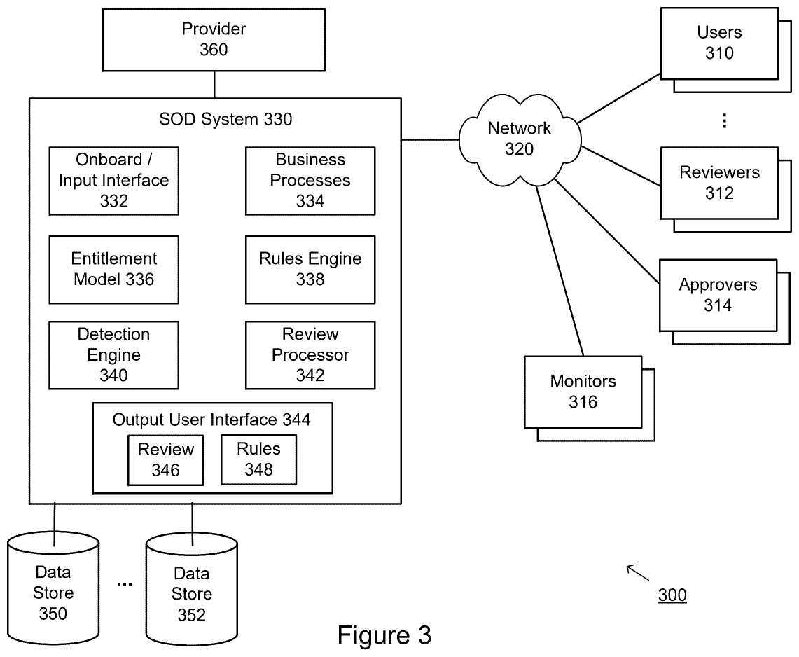

FIG. 3 is an exemplary system diagram, according to an embodiment of the present invention. FIG. 3 illustrates a schematic diagram of a system that implements Separation of Duties Based Conflict Detection and Resolution, according to an exemplary embodiment. As illustrated in FIG. 3, Network 320 may be communicatively coupled to SOD System 330 via various computing devices. Computing devices may include computers, laptops, workstations, kiosks, terminals, tablets, mobile devices, mobile phones, smart devices, etc. Various users may interact with SOD System 330 through Network 320. Users 310 may include Reviewers 312, Approvers 314 and Monitors 316.

Network 320 communicates with SOD System 330 that provides SOD based conflict detection and resolution. SOD System 330 may include Onboard/Input Interface 332, Business Processes 334, Entitlement Model 336, Rules Engine 338, Detection Engine 340, Review Processor 342 and Output User Interface 344.

Onboard/Input Interface 332 may interface with various systems to receive requests and entitlement data. An onboarding process may receive/ingest entitlements and associated metadata. This enables Onboard/Input Interface 332 to analyze hundreds and hundreds of entitlements by metadata. For example, an entitlement metadata may indicate a relation to payments entitlements. Accordingly, an embodiment of the present invention provides a metadata based input approach as opposed to relying on direct linkages to specific entitlements.

Business Processes 334 may analyze and manage various business processes related to an entity, application, industry, etc. Business Processes 334 may include trading, payments, settlements, etc. In this example, a business process based rule may indicate that the same person should not have an ability to execute trades and also approve payments.

In addition, when a system, application, service, etc. is onboarded, an embodiment of the present invention may identify relevant business processes for certain functions. For example, when a payment system is implemented, an embodiment of the present invention may recognize that the payment system is in scope for SOD controls for payment activities. The relevant business processes may be analyzed to identify SOD conflicts, according to an embodiment of the present invention.

Entitlement Model 336 may generate and refine a model that extracts entitlements from various business processes. While an Entitlement Model 336 is illustrated, other types of access and/or control may be considered.

Rules Engine 338 may include a processor that analyzes entitlement rules based on business processes.

Detection Engine 340 may include a processor that detects potential anomalies, conflicts, etc. Detection Engine 340 may be modelled to evaluate what an application can do, what an entitlement in an application gives user access to along with any indirect access to the system provided by the entitlements. It may be dependent on the taxonomy of functional processes which may be defined as a “Business Process.” These taxonomies may be utilized to assist with a scoping criteria for the detection logic as it helps classify the functions performed by various resources, including people and technology assets. The conflict may be calculated real time and mitigated during an approval process which may be a proactive control.

Review Processor 342 may apply a multi-step review process for entitlements and interact with various users including Reviewer, Approvers and Monitors.

Output User Interface 344 may include an interactive interface for analyzing, maintaining, and/or rejecting requests via Review 346. In addition, rules may be applied, defined, generated, modified, processed, etc. via Rules 348. Others users and integrations may be supported.

The system components are exemplary and illustrative, SOD System 330 may interact with additional modules, a combination of the modules described and/or less modules than illustrated. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. Other architectures may be realized.

SOD System 330 may be communicatively coupled to data storage devices represented by Data stores 350, 352. Data stores 350, 352 may also store and maintain entitlement data, business processes, taxonomies, source code, reports, performance data, historical data, etc. The conflict detection and resolution features described herein may be provided by SOD System 330 and/or a third party provider, represented by 360, where Provider 360 may operate with SOD System 330.

The system 300 of FIG. 3 may be implemented in a variety of ways. Architecture within system 300 may be implemented as hardware components (e.g., module) within one or more network elements. It should also be appreciated that architecture within system 300 may be implemented in computer executable software (e.g., on a tangible, non-transitory computer-readable medium) located within one or more network elements. Module functionality of architecture within system 300 may be located on a single device or distributed across a plurality of devices including one or more centralized servers and one or more mobile units or end user devices. The architecture depicted in system 300 is meant to be exemplary and non-limiting. For example, while connections and relationships between the elements of system 300 is depicted, it should be appreciated that other connections and relationships are possible. The system 300 described below may be used to implement the various methods herein, by way of example. Various elements of the system 300 may be referenced in explaining the exemplary methods described herein.

Network 320 may be a wireless network, a wired network or any combination of wireless network and wired network. Network 320 may further include one, or any number of the exemplary types of networks operating as a stand-alone network or in cooperation with each other. Network 320 may utilize one or more protocols of one or more network elements to which it is communicatively coupled. Network 320 may translate to or from other protocols to one or more protocols of network devices. Although Network 320 may be depicted as one network for simplicity, it should be appreciated that according to one or more embodiments, Network 320 may comprise a plurality of interconnected networks, such as, for example, a service provider network, the Internet, a cellular network, corporate networks, or even home networks, or any of the types of networks mentioned above.

Data may be transmitted and received via Network 320 utilizing a standard networking protocol or a standard telecommunications protocol. For example, data may be transmitted using protocols and systems suitable for transmitting and receiving data. Data may be transmitted and received wirelessly or in some cases may utilize cabled network or telecom connections or other wired network connection.

While FIG. 3 illustrates individual devices or components, it should be appreciated that there may be several of such devices to carry out the various exemplary embodiments. SOD System 330 may communicate using any mobile or computing device, such as a laptop computer, a personal digital assistant, a smartphone, a smartwatch, smart glasses, other wearables or other computing devices capable of sending or receiving network signals. Computing devices may have an application installed that is associated with Provider 360.

SOD System 330 may be communicatively coupled to Data Stores 350, 352 as well as remote storages. These storage components may include any suitable data structure to maintain the information and allow access and retrieval of the information. The storage may be local, remote, or a combination. The storage components may have back-up capability built-in. Communications with the storage components may be over a network, such as Network 320 or communications may involve a direct connection between the various storage components and Provider 360, as depicted in FIG. 3. The storage components may also represent cloud or other network based storage.

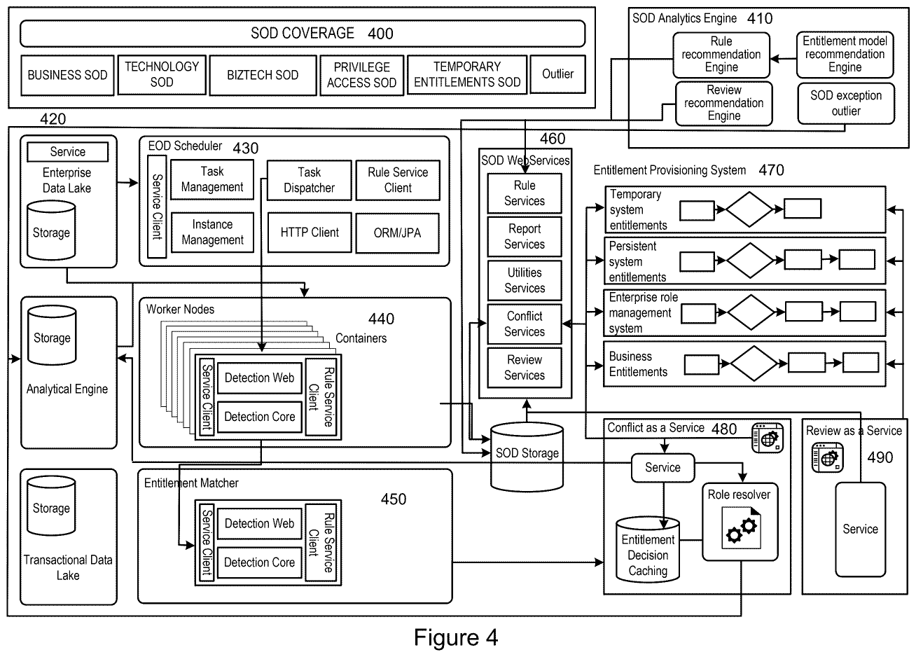

FIG. 4 is an exemplary architecture system diagram, according to an embodiment of the present invention. As shown by FIG. 4, SOD Coverage 400 may include Business SOD, Technology SOD, BizTech SOD, Privilege Access SOD, Temporary Entitlements SOD and Outlier. FIG. 4 illustrates a scalable system that may be applied to various use cases, applications scenarios, etc.

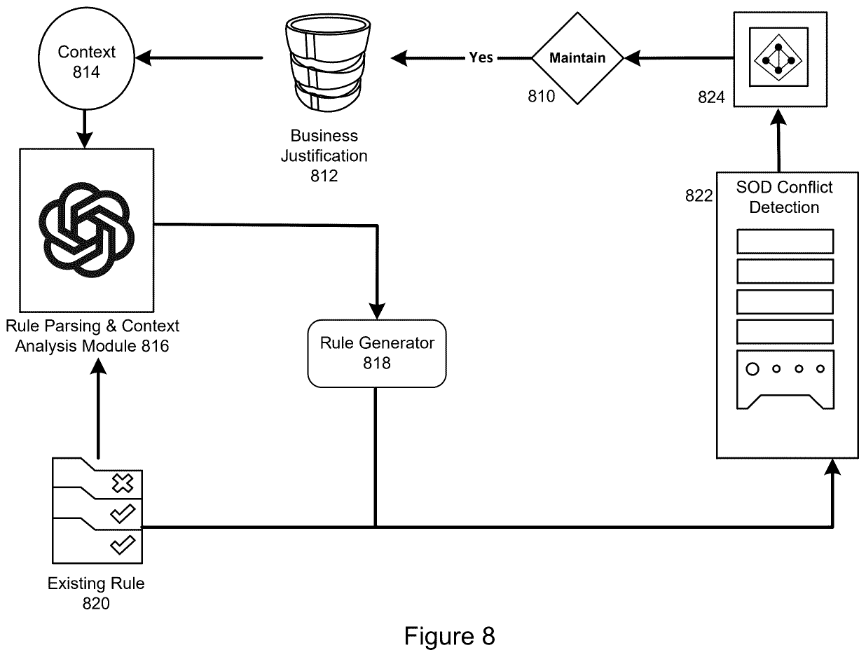

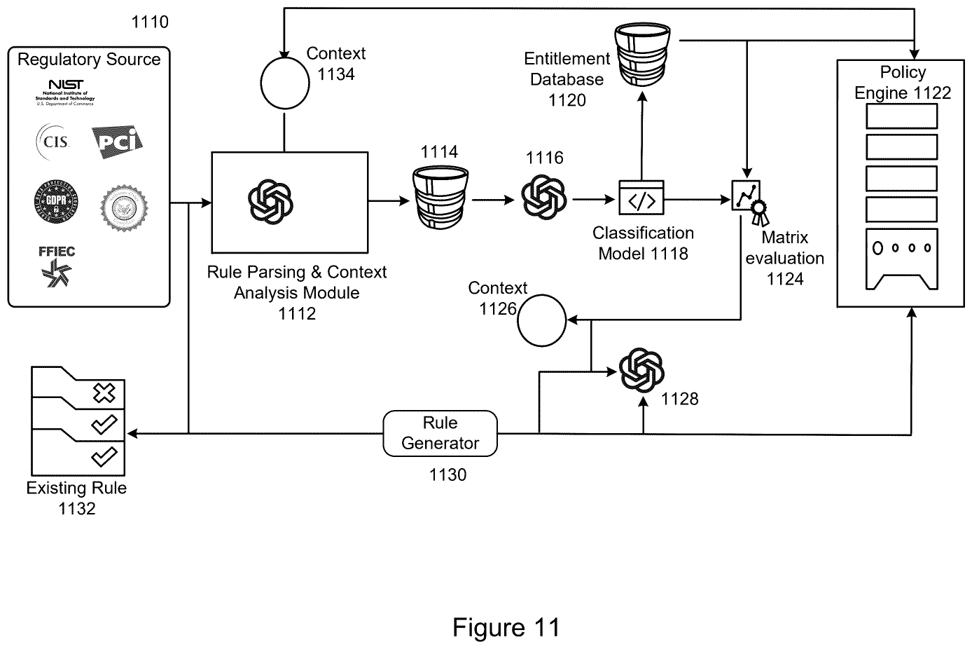

SOD Analytics Engine 410 may include: Rule Recommendation Engine, Entitlement Model Recommendation Engine, Review Recommendation Engine and SOD Exception Outlier. Rule Recommendation Engine and Entitlement Model Recommendation Engine are detailed in FIGS. 8 and 11 below. Review Recommendation Engine may represent an AI/ML based model that uses a classification model to recommend review decisions based on historical trend, user profile, etc. SOD Exception Outlier may represent an analytical process that analyzes data not considered for SOD/exception and evaluates whether the SOD Analytics Engine 410 has missed any patterns.

Services 420 may include EOD Scheduler 430, Worker Nodes 440 and Entitlement Matcher 450. EOD Scheduler 430 may include Service Client, Task Management, Instance Management, Task Dispatcher, HTTP Client, Rule Service Client, and ORM/JPA. Worker Nodes 440 may include a plurality of containers with Service Client, Detection Web, Detection Core and Rule Service Client. Entitlement Matcher 450 may include Service Client, Detection Web, Detection Core and Rule Service Client. Storage components may include Enterprise Data Lake, Analytical Engine, Transactional Data Lake. Task Dispatcher, as shown in section 430, and Worker Nodes 440 may represent a master slave architecture. Worker Nodes 440 represent containers executing in parallel. Task Dispatcher may create a task and dispatch it to a worker node. The worker node may work to complete the task. In this example, a master node keeps track of task status and once completed, it may assign a new task as part of horizontal scaling. Entitlement Matcher 450 may support avoiding recalculation until needed. For example, a rule in SOD may be two-sided. While EOD Scheduler 430 executes batch detection, an embodiment of the present invention continues to match entitlements to the rule which may be reused if a user requests new entitlements with any of these existing entitlements and thereby avoids recalculation.

SOD Web Services 460 may include: Rule Services, Report Services, Utilities Services, Conflict Services and Review Services. Entitlement Provisioning System 470 may include: Temporary System Entitlements, Persistent System Entitlements, Enterprise Role Management System and Business Entitlements.

Other Services may include: Conflict as a Service 480 and Review as a Service 490. Conflict as a Service 480 may include Service, Role Resolver and Entitlement Decision Caching. These Services may be called through an API or other interface.

An embodiment of the present invention provides a level of granularity and specificity of entitlements that may be leveraged to make intelligent decisions on whether a set of entitlements is a toxic combination and generate a conflict. An embodiment of the present invention is directed to a process that relies not just on the entitlement that is granted to the user but also on what the user can do using the same.

An embodiment of the present invention is directed to a proactive SOD risk management. SOD (Conflict As A Service) 480 provides a conflict service to various entity provision systems. When an entitlement is requested, SOD conflict may be calculated/determined in response. When a conflict is determined, a review process may be initiated at 490. Upon granting a SOD review process, the entitlement may then be approved. Accordingly, this process reduces risk of toxic entitlement combinations.

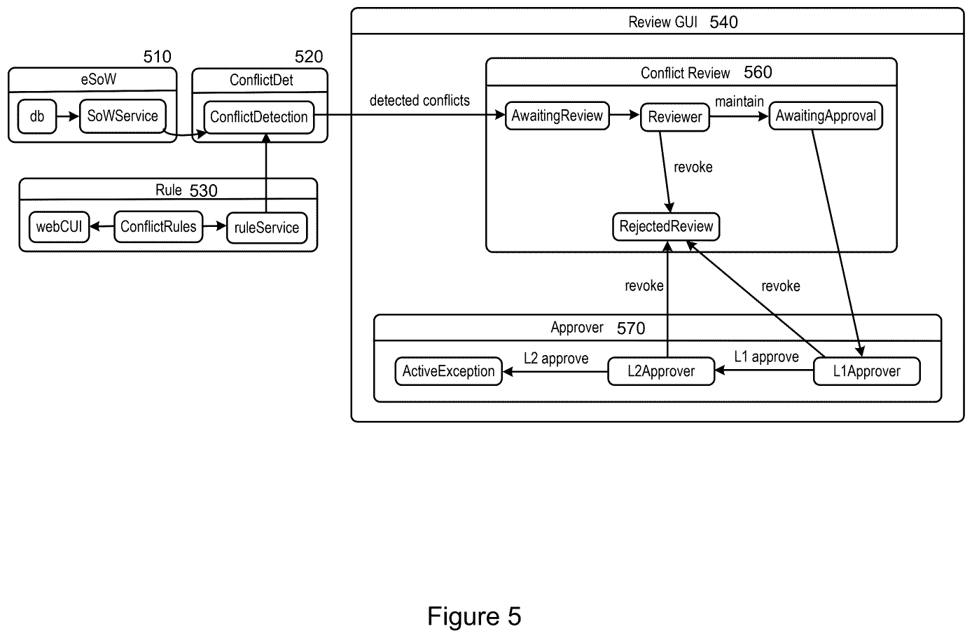

FIG. 5 is an exemplary review process, according to an embodiment of the present invention. FIG. 5 illustrates a conflict detection and conflict review overall process.

As shown in FIG. 5, eSOW 510 may access database (db) and send a SOW Service request to Conflict Detection 520. Conflict Detection 520 may access conflict rules through a web interface and/or rule service, as shown by Rule 530. Detected conflicts may be sent to Conflict Review 560. Through a review interface 540, a reviewer may access a detected conflict and then determine whether to maintain through awaiting approval or revoke through rejected review. Additional Approvers (L1 Approver and L2 Approver) may review and determine whether to revoke or process as an exception at 570.

An embodiment of the present invention is directed to a multi-step coverage-based review process that enhances accuracy and control. An embodiment of the present invention may support various types of users, including Reviewers, SOD Approvers (of varying levels), Monitors, etc.

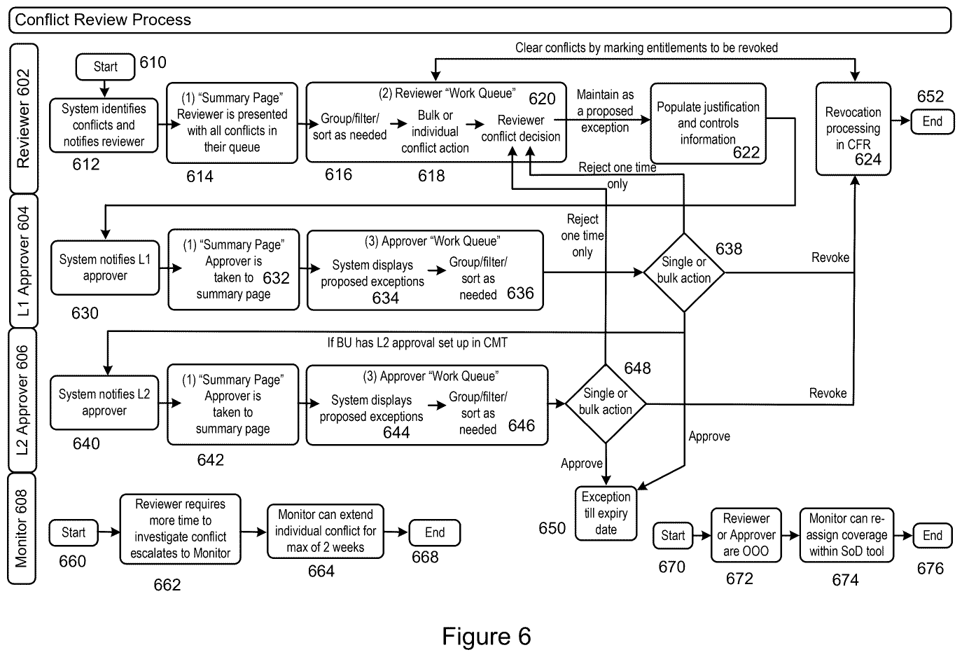

FIG. 6 is an exemplary conflict review process, according to an embodiment of the present invention. Various users including Reviewer 602, L1 Approver 604, L2 Approver 606 and Monitor 608 may interact with a conflict review process.

Reviewer 602 may be responsible for remediating/maintaining a conflict. If a conflict is maintained, a second level of approval may be required.

For all maintains, an approval may be required. The Approver (e.g., SOD Level 1Approver) 604 may review the maintained conflicts and rationale provided by a Reviewer.

A second level of approval may be available to business units. This additional Approver (e.g., SOD Level 2 Approver) 606 may be given additional time to approve, e.g., 5 days.

Monitors 608 may need to follow-up with Reviewers and Approvers for pending violations. Monitors 608 may also be responsible for filling coverage gaps to ensure timely review completion for their area. Other types of reviewers with varying levels of responsibilities may be supported.

A conflict review process may start at 610 where a system identifies a conflict and notifies a reviewer at 612. Through an interface (e.g., summary page), the reviewer may be presented with conflicts in a queue at 614. Through a work queue interface, the reviewer may process the conflicts through group, filter, sort as needed at 616. Bulk or individual conflict action may be determined at 618. A conflict decision may be determined at 620.

Conflicts may be cleared by marking entitlements to be revoked at Revocation Processing in CFR (Revocation Engine) 624. CFR 624 may represent a centralized entitlement revocation platform that views and updates revocations generated by an entitlement revocation process. Entitlements may be maintained as a proposed exception and population justification and controls information at 622. According to an exemplary illustration, the entitlement may be rejected one time only. Other conditions may be applied.

The system may notify L1 approver at 630. The approver may be presented with an interface (e.g., summary page) at 632. Through a work queue interface, the approver may view proposed exceptions at 634 and group, filter, sort as needed, at 636. Actions may be determined as single or bulk actions at 638. The exception may be revoked at Revocation Processing in CFR, at 624. If a business unit has L2 Approval set up, the system may notify L2 approver, at 640.

The approver may be presented with an interface (e.g., summary page) at 642. Through a work queue interface, the approver may view proposed exceptions at 644 and group, filter, sort as needed at 646. Actions may be determined as single or bulk actions at 648. The exception may be revoked at Revocation Processing in CFR at 624. The exception may be approved until an expiry date or other condition. The process may end at 652.

For Monitor, a process may start at 660 where a Reviewer may require more time to investigate a conflict which may then be escalated to Monitor at 662. Monitor may extend an individual conflict for a period of time at 664. The process may end at 668. Another process may start at 670 where a reviewer or approver is out of office at 672. Monitor may reassign coverage within SOD tool at 674 and the process ends at 676.

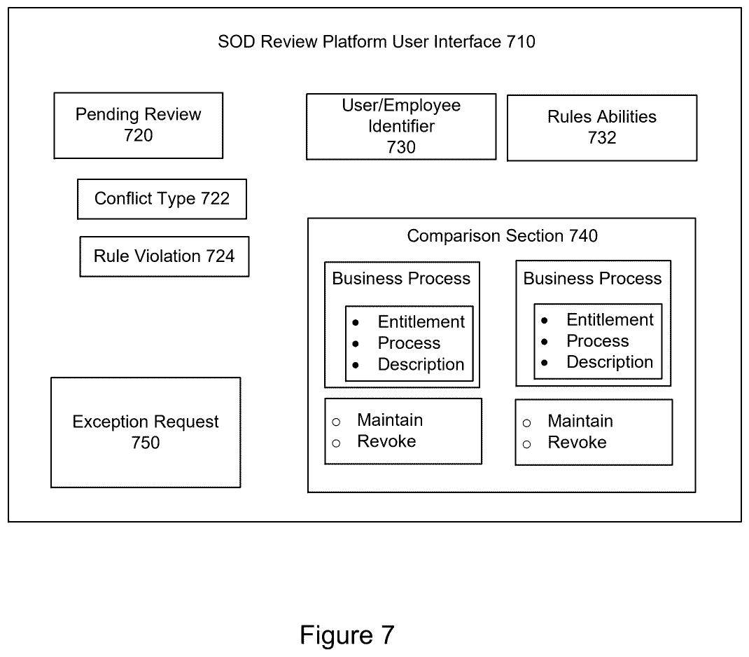

FIG. 7 is an exemplary user interface, according to an embodiment of the present invention. SOD review portal may resolve SOD rules based on business processes and further highlight combinations of entitlements that are creating conflicts. It allows an opportunity to a reviewer to evaluate and determine whether entitlements should be revoked in order to remove conflicts or whether there is a genuine use case to maintain entitlements for a limited duration or other condition.

As shown FIG. 7, a user interface (as shown by SOD Review Platform User Interface 710) may include various interactive sections including: Pending Review 720 and Comparison Section 740. Pending Review 720 may enable filtering by conflict type 722 (e.g., Biztech SOD, Business SOD, Technology SOD, Outliers, etc.) as well as other metrics/characteristics. Pending Review 720 may identify a user and associated violations of specific rules (e.g., user identifier, rule identifier, etc.) at 724. Additional information regarding the user may be provided at 730 and what the user is able to do at Rule Abilities 732. This may include user identifier, division, cost center, enterprise role, associated rules and abilities.

The Comparison Section 740 may compare a first set of business processes and a second set of business processes. Business Processes may include: identifier, (parent) entitlement name, business process (e.g., calculate daily risk, execute trade), entitlement description (e.g., ability to run risk, sales users can book, amend and cancel trades), etc. Comparison Section 740 may enable the user to maintain or revoke business processes.

If the reviewer decides to maintain the entitlement, proper control details may be added. For example, a limited set of control and justification categories may be allowed to maintain entitlement for a maximum allowed time limit. Other conditions may be provided.

A Rule Exception Request Interface, as shown by Exception Request 750, may enable a user to identify Control Type; Control Category Comment; Justification Category, Business Justification, Expiration Date and Comments. An exception management feature of an embodiment of the present invention enables a reviewer to propose an exception and further manage those exceptions.

FIG. 8 is an exemplary flowchart, according to an embodiment of the present invention. An embodiment of the present invention is directed to an AI-based rule recommendation using a review decision feedback loop.

As part of regular review cycle when conflicting entitlements are maintained at 810 along with control type and justification category, business justification 812 may also be provided. AI/ML model through Rule Parsing and Content Analysis Module 816 may be applied to comments (or other context shown by 814) as a commentary feedback loop and generate rule modification at 818. The comments and/or feedback loop may then be evaluated and vetted against current rule engine (as shown by Existing Rule 820) to validate through SOD Conflict Detection 822 and SOD Review Process 824. As shown in FIG. 8, each SOD conflict may have an associated review process where the decision may include: maintain or revoke. When the decision includes maintaining an entitlement for a conflict, a business team may be asked to provide additional justification. This may involve identifying a different justification category. The AI/ML or GenAI model may analyze the justifications along with rules and entitlement model and then generate a modified/new rule or recommend entitlement reclassification. Other actions/responses may be generated.

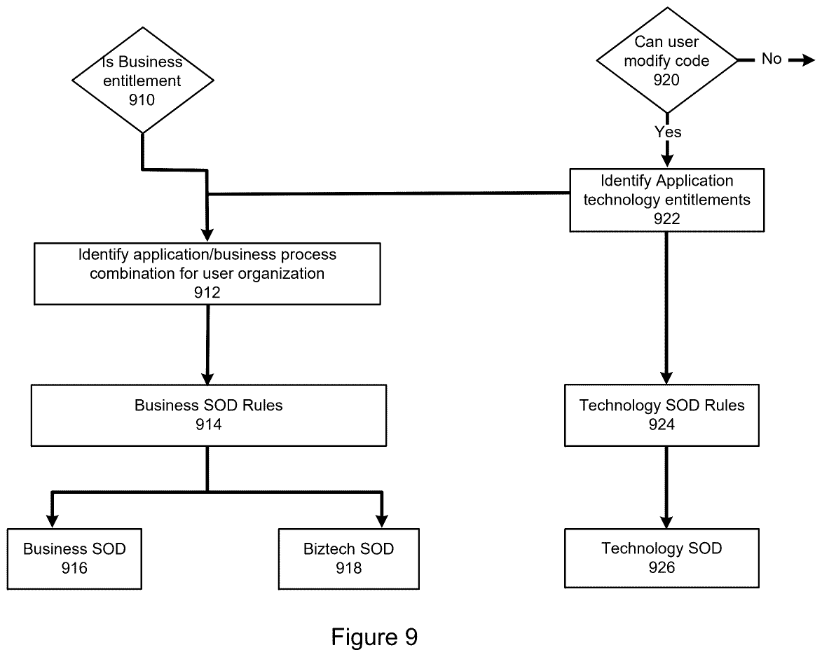

FIG. 9 is an exemplary flowchart, according to an embodiment of the present invention. FIG. 9 illustrates an ability to define and manage rules per different business and technology functions that exist in an entity.

As shown in FIG. 9, step 910 may determine whether the entitlement is a business entitlement. Step 912 may identify application/business process combinations for an entity or a user's user organization. Step 914 may generate and apply business SOD rules including Business SOD 916 and BizTech SOD 918. Step 920 may determine whether the user can modify code. If yes, step 922 may identify application technology entitlements. If no and the role is not determined to modify code, conflicts are not applied and the process may proceed. Step 924 may generate and apply technology SOD rules at Technology SOD Rules 924 (rules specific to Technology SOD) and Technology SOD 926 (Technology SOD Conflict detection process based on 924).

Various rule combinations may include: Business Entitlement Conflict Detection; Technology Entitlement Conflict Detection and Business Conflict resulting from System Entitlements. Other combinations may be supported.

Business Entitlement Conflict Detection may include making determinations between rules such as: Process vs Process Rule; Organization vs Process Rule; etc.

With Technology Entitlement Conflict Detection, developers may have entitlements on production assets and/or sensitive data.

As for Business Conflict resulting from System Entitlement, when a user is provisioned technology entitlements, entitlement models may be created and the mapping of those entitlements with business processes may be generated. Once Business processes associated with user is collected, various processes combinations may be evaluated to determine whether they are creating conflicts or with the organization of user. Such a detection may be flagged as Biztech conflict.

An embodiment of the present invention may be applied to various use cases including business owned rules. For example, an embodiment of the present invention is directed to addressing organization wise entitlement outliers. A cost center outlier may represent a business unit owned analytics-based conflict detection. The engine may perform a clustering of users at a cost center (organization hierarchy) level. Once the scope if defined entitlement grouping of users are performed. Based on the commonality of entitlement in that group is detected (in percentage), the rule to filter out all the user and entitlement falling under defined threshold and flag it as conflict to be reviewed.

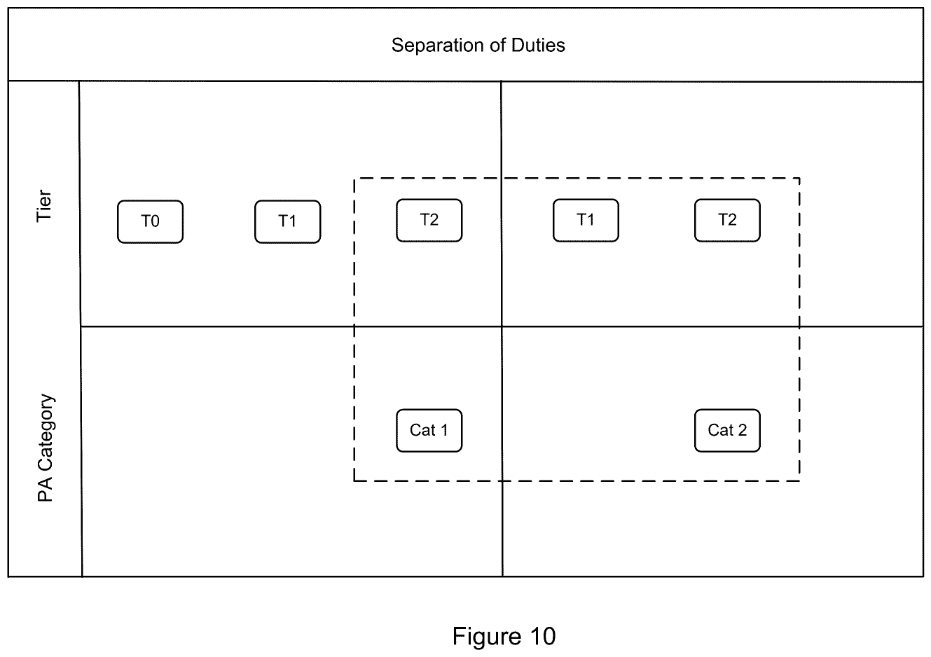

FIG. 10 is an illustration of privileged entitlements conflicts, according to an embodiment of the present invention. FIG. 10 illustrates separation of duties through Tier and PA categories.

A Privileged Access (PA) may provide a user or process the ability to grant access, modify assets (e.g., systems, applications, data) and/or modify controls around assets with broad scope of impact to systems and platforms affecting the Confidentiality, Integrity and/or Availability. Privileged Access entitlements may be used for an administration. Examples may include: UNIX root; database SA entitlements; Active Directory administrative rights; Privileged Control Access Tier; etc.

As shown in FIG. 10, PA critical entitlements may be fenced into tiers based on a tier classification entitlement risk score and/or other metrics. Two low score tiers may be combined in a manner that creates potential risk, e.g., anyone with Tier 1/2 access on Windows that also has a download, write to USB or browse web exception may indicate risk as this person may potentially exploit both these entitlement together. Accordingly, SOD rules may be applied to identify these combinations to reduce potentially high risk scenarios.

An embodiment of the present invention is directed to information barrier conflicts. For example, a user may be provided an information barrier status based on the user's job role. An embodiment of the present invention may extract an entitlement for a user and extract an underlying application classification of the entitlement. If the classification is different material non-public information (MNPI) flag (e.g., Business activity and Client information), any user with a public information barrier status should not be able to access it. MNPI flag may represent corporate news or information that has not yet been made public and which could also have an impact on its share price.

As recognized by an embodiment of the present invention, some entitlements may expose certain types of sensitive data that may be protected by information barrier components. Other types of indirect access points that may potentially expose sensitive data may be considered as well. Accordingly, an embodiment of the present invention may extend to indirect access points and other interactions that may expose certain types of protected information, data, etc.

An embodiment of the present invention may be directed to applying technology controls against business conflicts. A business SOD conflict may involve an ability to book a trade but not being able to clear the trade. In this example, a user may have access to a database that could potentially invoke a set of related business controls. An embodiment of the present invention may be directed to merging technical access with business process functionality. Accordingly, an embodiment of the present invention addresses indirect system access where a user may be indirectly given a business entitlement or access that would otherwise be restricted.

An embodiment of the present invention may be directed to offering self-service for rule governance along with an annual attestation process and change management for the rule's definition changes. A rule visualizer capability may offer options to users for self-service for rule governance, auditable versioning, zero-time deployment of rule definition to production, ServiceNow controlled rule management and attestation process for the rules.

FIG. 11 is an exemplary flowchart, according to an embodiment of the present invention. An embodiment of the present invention recognizes that with the rapid evaluation of digital technologies, businesses face increasing challenges to develop and maintain up-to-date technology policies that comply with regulatory standards, industry best practices and unique organization needs. Significant resources are spent in interpreting these policies, creating rules often lagging behind emerging trends, which increase exposure of compliance risk.

An embodiment of the present invention is directed to a Tool that expands Separation of Duties to cater to these needs by leveraging Generative AI (“GenAI”) to produce customizable, context aware SOD policies.

As shown in FIG. 11, the Tool may web scrap various regulator portals 1110, such as GDPR, HIPAA, SOX, PCI to extract IAM policies at Rule Parsing and Context Analysis Module 1112 to extract SOD policies. The Tool then pass these policies and existing SOD rules templates 1132 as a context 1126 into GenAI 1128 to generate a new SOD rule description, modify existing rules (as shown by 1130) or recommend a change in existing entitlement model. Based on the new SOD rule description, the Tool may create a clustering based on unsupervised learning (e.g., k-means plus and random forest models) to identify entitlement attributes and values which are closer to generated policies. These attributes may be passed as a Context 1134 to GenAI (as shown by 1112) to generate SOD new rules/modify existing rule. SOD calculations, as shown by Classification Model 1118, may be run on these rules and the output may be evaluated and also stored in Entitlement Database 1120. Matrix Evaluation 1124 (e.g., major Matrix based on Accuracy, Precision, Recall, F1 Score, ROC Curve and AUC, Confusion Matrix, etc.) may evaluate the model and modify the model based on matrix feedback. As shown by FIG. 11, Policy Engine 1122 provides up-to-date technology policies that comply with regulatory standards, industry best practices and unique organization needs.

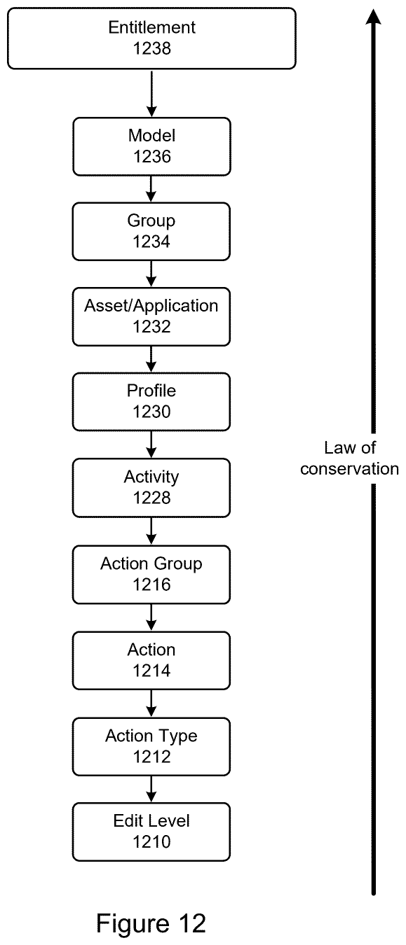

FIG. 12 is an exemplary diagram, according to an embodiment of the present invention. FIG. 12 illustrates how an entitlement model may be defined.

According to an exemplary illustration, Edit Level 1210 may represent basic read/write functions. Action Type 1212 may represent a specific action or function as shown by 1214. Action Group 1216 may represent groups of actions. These groups may then be represented as an Activity 1228. Under Profile 1230, different activities that a specific user may perform may be identified. Profiles may be matched to an Asset or Application, as shown by 1232. Multiple assets may be grouped together (as shown by Group 1234) for a particular entitlement 1238, which may be mapped and modeled as shown by 1236.

According to an embodiment of the present invention, Entitlements may represent a combination and hierarchy of Asset, Environment, Profile, Activity, Action, Edit Level and Business Process assigned to a user and/or a role. A model may simplify the complex entitlement hierarchy to resolve a Business Process, Environment and Edit Level information for entitlement based on a law of conservation, which enables the rules to be implemented on these entitlements.

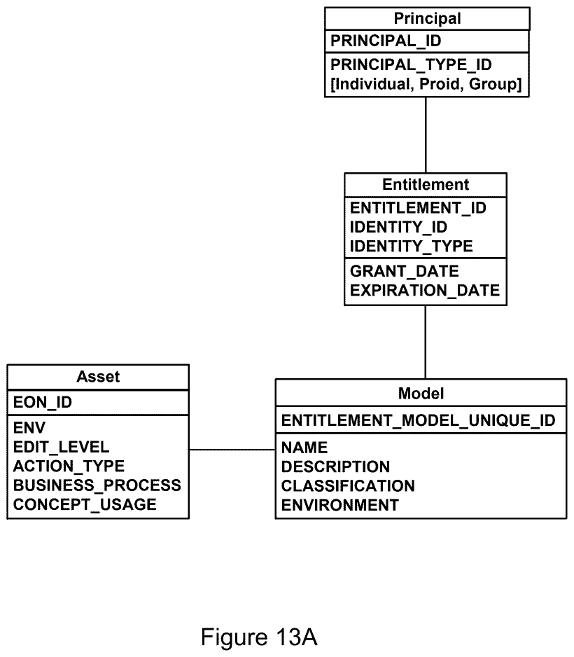

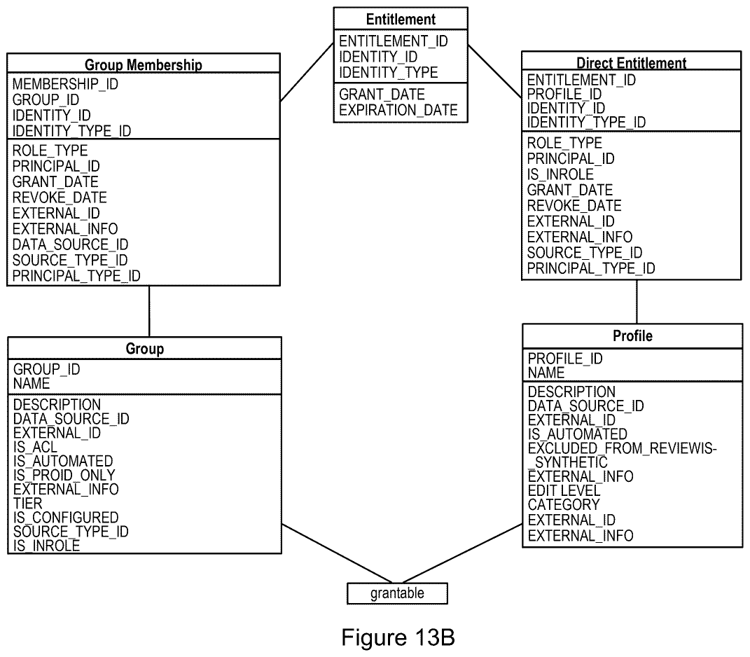

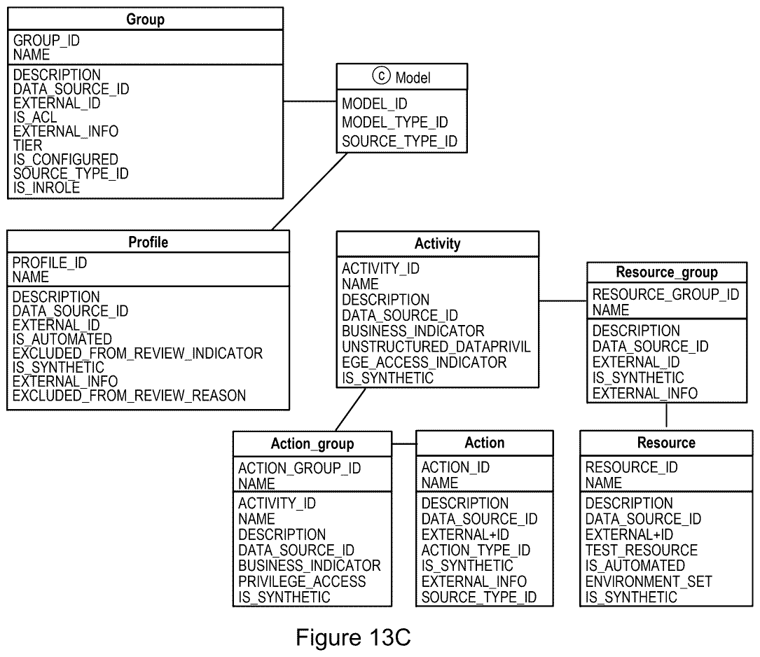

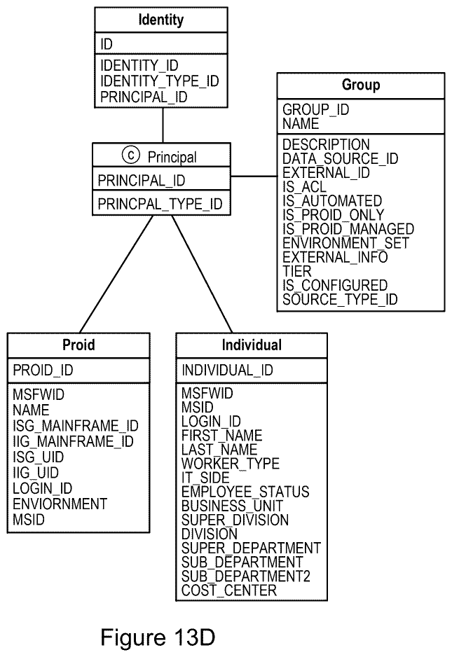

FIGS. 13A-D illustrate exemplary data structures, according to an embodiment of the present invention. FIG. 13A illustrates an Entitlement Model Overview. FIG. 13B illustrates an Entitlement Subject Area. FIG. 13C illustrates a Model Subject Area. FIG. 13D illustrates a Principal Subject Area.

An embodiment of the present invention is directed to entitlements based on a law of conservation. Entitlement models may create a linear/acyclic hierarchy of entitlement objects in an order shown FIGS. 13-16.

For business entitlements, there is an entitlement level classification that determines what are eligible business entitlements. Important attributes for Business SOD conflict detection may include: a Business process taxonomy hierarchy, an Organization hierarchy of human user, an environment of entitlement profile based on asset classification edit level of business process and role of the user. Environments may be defined at an asset level based on system classifications. Entitlements may be hierarchical in nature so that a model may then calculate an environment rollup from underlying assets for an entitlement.

For example, if an entitlement has more than one asset and one or more of them is a production application then by applying the law of conservation, the top level entitlement environment becomes production similarly business process are mapped to one or more than one entitlements. An embodiment of the present invention may then perform reverse mapping to find flattened business processes under an entitlement and roll up edit level of business process and edit level at entitlement model level and apply law of conservation so if one of edit level is write access then model get write classification.

For Technology entitlements user who have modify code privilege and tagged as developer role and scoped for calculation. Important attributes in the calculation may include: Environment, Edit Level, Data Sensitivity, Sox Flag for application. Environment, Sox may represent an application flag and edit level are activity and action type flag. These flags may be resolved by aggregating (max logic) to entitlement level and calculated.

There are also application and entitlement flags which validate if a position is eligible for review based on application/entitlement processes is there a control process in process or if it is an automated process.

The system components are exemplary and illustrative, an embodiment of the present invention may interact with additional modules, a combination of the modules described and/or less modules than illustrated. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. Other architectures may be realized.

The illustrated system may be communicatively coupled to various Data Stores as well as remote storages. Data stores may also store and maintain source code, reports, performance data, historical data, etc. These storage components may include any suitable data structure to maintain the information and allow access and retrieval of the information. The storage may be local, remote, or a combination. The storage components may have back-up capability built-in. Communications with the storage components may be over a network or communications may involve a direct connection between the various storage components. The storage components may also represent cloud or other network based storage.

The system may be implemented in a variety of ways. Architecture within the system may be implemented as hardware components (e.g., module) within one or more network elements. It should also be appreciated that architecture within the system may be implemented in computer executable software (e.g., on a tangible, non-transitory computer-readable medium) located within one or more network elements. Module functionality of architecture within the system may be located on a single device or distributed across a plurality of devices including one or more centralized servers and one or more mobile units or end user devices. The architecture depicted in the system is meant to be exemplary and non-limiting. For example, while connections and relationships between the elements of system are depicted, it should be appreciated that other connections and relationships are possible. The system described may be used to implement the various methods herein, by way of example. Various elements of the system may be referenced in explaining the exemplary methods described herein.

Networks may be a wireless network, a wired network or any combination of wireless network and wired network. Networks may further include one, or any number of the exemplary types of networks operating as a stand-alone network or in cooperation with each other. Networks may utilize one or more protocols of one or more network elements to which it is communicatively coupled. Networks may translate to or from other protocols to one or more protocols of network devices. Although Networks may be depicted as one network for simplicity, it should be appreciated that according to one or more embodiments, Networks may comprise a plurality of interconnected networks, such as, for example, a service provider network, the Internet, a cellular network, corporate networks, or even home networks, or any of the types of networks mentioned above.

Data may be transmitted and received via Networks utilizing a standard networking protocol or a standard telecommunications protocol. For example, data may be transmitted using protocols and systems suitable for transmitting and receiving data. Data may be transmitted and received wirelessly or in some cases may utilize cabled network or telecom connections or other wired network connection.

While the figures illustrate individual devices or components, it should be appreciated that there may be several of such devices to carry out the various exemplary embodiments. The system may communicate using any mobile or computing device, such as a laptop computer, a personal digital assistant, a smartphone, a smartwatch, smart glasses, other wearables or other computing devices capable of sending or receiving network signals. Computing devices may have an application installed that is associated with the illustrated system.

Those skilled in the art will appreciate that the diagrams discussed above are merely examples of a system and a method for implementing a separation of duties based conflict detection and resolution platform. Other types and configurations of networks, servers, databases and personal computing devices (e.g., desktop computers, tablet computers, mobile computing devices, smart phones, etc.) may be used with exemplary embodiments of the invention.

Although the foregoing examples show the various embodiments of the invention in one physical configuration, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. The components of the various embodiments may be arranged at any location or locations within a distributed network without affecting the operation of the respective system.

Although examples of servers, databases, and personal computing devices have been described above, exemplary embodiments of the invention may utilize other types of devices whereby a user may interact with a network that transmits and delivers data and information used by the various systems and methods described herein. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art.

In some embodiments, the computing devices may be equipped with an integral or connectable liquid crystal display (LCD), electroluminescent display, a light emitting diode (LED), organic light emitting diode (OLED) or another display screen, panel or device for viewing and manipulating files, data and other resources, for instance using a graphical user interface (GUI) or a command line interface (CLI). The personal computing devices may also include a network-enabled appliance or another TCP/IP client or other device.

The servers, databases, and personal computing devices described above may include at least one accelerated processing unit, such as a GPU or FPGA, and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software. The modules described above may comprise software stored in the memory (e.g., non-transitory computer readable medium containing program code instructions executed by the processor) for executing the methods described herein.

Any suitable programming language may be used in accordance with the various embodiments of the invention. For example, the programming language used may include assembly language, Ada, APL, Basic, C, C++, dBase, Forth, HTML, Android, IOS, .NET, Python, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

The software, hardware and services described herein may be provided utilizing one or more cloud service models, such as Software-as-a-Service (Saas), Platform-as-a-Service (PaaS), Infrastructure-as-a-Service (IaaS), and Logging as a Service (LaaS), and/or using one or more deployment models such as public cloud, private cloud, hybrid cloud, and/or community cloud models.

In the system and method of exemplary embodiments of the invention, a variety of “user interfaces” may be utilized to allow a user to interface with the personal computing devices. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor.

Although the embodiments of the invention have been described herein in the context of a particular implementation in a particular environment for a particular purpose, those skilled in the art will recognize that its usefulness is not limited thereto and that the embodiments of the invention can be beneficially implemented in other related environments for similar purposes.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents. The specification and drawings are accordingly to be regarded as an illustrative rather than restrictive sense.

1. A separation of duties based conflict detection and resolution system comprising:
a computer server comprising one or more processors;
a database storing business rules data; and
non-transitory memory comprising instructions that, when executed by the one or more processors, cause the one or more processors to:
identify, via the one or more processors, one or more business processes for an application implemented by an entity;
for each business process, determine, via the one or more processors, a set of entitlements comprising a combination of: indirect entitlements, inheritance entitlements and root entitlements, wherein determining the set of entitlements comprises performing an electronic trace through an entire tree through multiple layers of indirection across an acyclic entitlement hierarchy to identify indirect entitlements and inheritance entitlements that would be undetected at a group level assignment and to identify what a user is allowed to do;
determine, via the one or more processors, a set of capabilities associated with the user;
execute, via a detection engine, a set of policy-based rules to detect one or more separation of duties (SOD) conflicts for the user and the set of entitlements by evaluating the application processes and functions, user access to and capability in the application provided by the set of entitlements, and indirect access to the application attained through inheritance of the set of entitlements;
provide, via the one or more processors, a coverage-based review for the one or more separation of duties conflicts;
determine, via an interactive interface, whether to maintain each of the set of entitlements wherein a determination to maintain an entitlement comprises identifying a reason through a user input and the interactive interface captures the user input and applies the user input to an artificial intelligence/machine learning (AI/ML) model to generate a rule modification;
execute one or more application programming interfaces (APIs) to implement access control changes, comprising approval or revocation, across the application based on an approval of the determination to maintain the entitlement; and
provide iterative feedback to the detection engine using a generative artificial intelligence (AI) model, based on the determination to maintain the entitlement to improve conflict detection;
apply an output of the determination to maintain the entitlement to the detection engine to improve detection of the one or more SOD conflicts by analyzing user-provided descriptions relating to maintaining entitlements that align with the set of policy-based rules; and
process, by the generative AI model, the user-provided descriptions to generate a new SOD rule description or modify an existing SOD rule based on context from existing SOD rules templates;
wherein the generated or modified SOD rule definition is applied by the detection engine in a subsequent detection cycle to identify conflict patterns not previously detected, and
wherein conflict detection is executed using distributed worker nodes that process entitlement data in parallel.

2. The system of claim 1, wherein the set of entitlements comprises a combination of a hierarchy of asset, environment, profile, activity, action, edit level and business process assigned to a user and a role.

3. (canceled)

4. (canceled)

5. (canceled)

6. The system of claim 1, wherein the detection engine is dependent on a taxonomy of the one or more business processes.

7. The system of claim 6, wherein the taxonomy is utilized to assist with scoping criteria for a detection logic to classify a plurality of functions performed by one or more resources comprising users and technology assets.

8. (canceled)

9. (canceled)

10. The system of claim 1, wherein the coverage-based review comprises a multi-step process involving a reviewer, at least one approver and a monitor.

11. A computer-implemented monitoring method comprising the steps of:
identifying one or more business processes for an application implemented by an entity;
for each business process, determining a set of entitlements comprising a combination of: indirect entitlements, inheritance entitlements and root entitlements, wherein determining the set of entitlements comprises performing an electronic trace through an entire tree through multiple layers of indirection across an acyclic entitlement hierarchy to identify indirect entitlements and inheritance entitlements that would be undetected at a group level assignment and to identify what a user is allowed to do;
determining a set of capabilities associated with the user;
executing, via a detection engine, implemented a processor, a set of policy-based rules to detect one or more separation of duties (SOD) conflicts for the user and the set of entitlements by evaluating the application processes and functions, user access to and capability in the application provided by the set of entitlements, and indirect access to the application attained through inheritance of the set of entitlements;
providing a coverage-based review for the one or more separation of duties conflicts;
determining, via an interactive interface, whether to maintain each of the set of entitlements wherein a determination to maintain an entitlement comprises identifying a reason through a user input wherein the interactive interface captures the user input and applies the user input to an artificial intelligence/machine learning (AI/ML) model to generate a rule modification;
executing one or more application programming interfaces (APIs) to implement access control changes across the application based on the determination to maintain the entitlement; and
providing feedback to the detection engine using a generative artificial intelligence (AI) model, based on the determination to maintain the entitlement to improve conflict detection;
apply an output of the determination to maintain the entitlement to the detection engine to improve detection of the one or more SOD conflicts by analyzing user-provided descriptions relating to maintaining entitlements to generate insights that align with the set of policy-based rules; and
processing, by the generative AI model, the user-provided descriptions to generate a new SOD rule description or modify an existing SOD rule based on context from existing SOD rules templates;
wherein applying the generated or modified SOD rule definition to the detection engine improves detection of the one or more SOD conflicts by identifying conflict patterns not previously detected and avoiding recalculation of previously resolved conflicts., and
wherein conflict detection is executed using distributed worker nodes that process entitlement data in parallel.

12. The method of claim 11, wherein the set of entitlements comprises a combination of a hierarchy of asset, environment, profile, activity, action, edit level and business process assigned to a user and a role.

13. (canceled)

14. (canceled)

15. (canceled)

16. The method of claim 11, wherein the detection engine is dependent on a taxonomy of the one or more business processes.

17. The method of claim 16, wherein the taxonomy is utilized to assist with scoping criteria for a detection logic to classify a plurality of functions performed by one or more resources comprising users and technology assets.

18. (canceled)

19. (canceled)

20. The method of claim 11, wherein the coverage-based review comprises a multi-step process involving a reviewer, at least one approver and a monitor.
